(19) United States
(12) Patent Application Publication
(10) Pub. No.: US 2013/0223369 A1
(43) Pub. Date: Aug. 29, 2013

(54) METHOD, PUBLIC LAND MOBILE NETWORK AND USER EQUIPMENT

(71) Applicants: Karl Heinz Nenner, Bornheim (DE); Dieter Jacobsohn, Bonn (DE)

(72) Inventors: Karl Heinz Nenner, Bornheim (DE); Dieter Jacobsohn, Bonn (DE)

(73) Assignee: DEUTSCHE TELEKOM AG, Bonn (DE)

(21) Appl. No.: 13/813,667

(22) PCT Filed: Aug. 3, 2011
(86) PCT No.: PCT/EP2011/003884

§ 371 Date: Mar. 13, 2013

Related U.S. Application Data
(60) Provisional application No. 61/370,609, filed on Aug. 4, 2010.

(30) Foreign Application Priority Data
Aug. 4, 2010 (EP) 10008131.4

(51) Int. Cl. H04W 60/00

(52) U.S. Cl. CPC H04W 60/00
USPC 370/329

(57) ABSTRACT

A method for providing an access control of a User Equipment to a public land mobile network, the User Equipment being configured to be capable of a first kind of access and a second kind of access to the public land mobile network, includes: realizing access control to the public land mobile network by at least one of connecting the User Equipment to the public land mobile network according to the first kind of access based on a first access control information; or connecting the User Equipment to the public land mobile network according to the second kind of access based on a second access control information.

### BACKGROUND

The present invention relates to a method, a public land mobile network and a User Equipment for providing an access control of the User Equipment to the public land mobile network. According to the present invention, an efficient configuration of the network access control of User Equipments is possible, especially regarding those network access requests involved in the use of Packet Switched (PS) domain related traffic.

During the early years of 2G mobile networks, such as GSM, there was only a Circuit Switched (CS) domain of the network. A mobile terminal would attach to the network upon power-up (so-called IMSI Attach), after which it is reachable for mobile originating or mobile terminating Circuit Switched (CS) services (voice, SMS, or the like).

In GSM Release 97, a packet switched domain was added to the network in the form of the General Packet Radio Service (GPRS). Typically, public land mobile networks today support either Circuit Switched (CS) only, or both CS and GPRS. It is also possible for a public land mobile network to support GPRS only.

Both Circuit Switched (CS) and Packet Switched (PS) domains of the network have been extended for use with Universal Mobile Telecommunication System (UMTS) following 3GPP Release 99. With these extensions, Circuit Switched (CS) and Packet Switched (PS) services became usable via both the 2G GSM radio access (GERAN) and the 3G UMTS radio access (UTRAN), and their later enhancements (EDGE, HSPA).

In order to use General Packet Radio System (GPRS), a terminal first has to perform another attachment, the so-called GPRS Attach. Unlike in the Circuit Switched (CS) domain of the network, this attachment is not sufficient, however: the terminal, once General Packet Radio System (GPRS) attached, also has to obtain a so-called “PDN connection”, which provides access to a specific packet data network (PDN) (e.g., the Internet) via a specific access point, both being identified by an Access Point Name (APN). Through the activation of a Packet Data Network (PDN) connection, the terminal also obtains communication parameters for the external packet network. It is only after the activation of a Packet Data Network (PDN) connection that the terminal can communicate, and is reachable, via the external packet data network.

Enhancements to General Packet Radio System (GPRS) have been standardized in 3GPP in order to accommodate the next generation radio system, commonly known as LTE or Evolved Universal Terrestrial Radio Access Network (E-UTRAN). A network comprising those General Packet Radio System (GPRS) enhancements and Evolved Universal Terrestrial Radio Access Network (E-UTRAN) is called the Evolved Packet System (EPS) in 3GPP. The Evolved Packet System (EPS) also provides enhancements to the General Packet Radio System (GPRS) core used to serve the existing GERAN and UTRAN radio accesses.

One of the novelties of Evolved Packet System Network (EPS) is its lack of a Circuit Switched (CS) domain, i.e. all services are provided via the PS domain. In order to overcome the “reachability problem” that occurs in General Packet Radio System (GPRS), a PDN connection is automatically established for the terminal (hereinafter also called User Equipment) when it attaches to the Evolved Packet System (EPS) via Evolved Universal Terrestrial Radio Access Network (E-UTRAN), or moves from a GERAN/UTRAN cell into an Evolved Universal Terrestrial Radio Access Network (E-UTRAN) cell.

In the future, it is possible that the Circuit Switched (CS) domain of the network will be disabled in GERAN and/or UTRAN in order to provide all services via the Packet Switched (PS) domain irrespective of whether the User Equipment accesses the network via GERAN, UTRAN or Evolved Universal Terrestrial Radio Access Network (E-UTRAN). This is favourable e.g. in order to refarm GERAN or UTRAN spectrum for Evolved Universal Terrestrial Radio Access Network (E-UTRAN), or in order to fully leverage the higher cell capacity of HSPA compared to WCDMA on UTRAN.

According to the prior art, User Equipments may be configured:
whether to perform General Packet Radio System (GPRS) Attach upon power-on, or
whether User Equipments always perform GPRS Attach upon power-on without any configuration possibility, or
whether User Equipments may be configured to always activate a PDN connection, with or without a configured APN, globally or per application, or
whether User Equipments may be configured, with or without a configured APN, globally or per application, to activate a PDN connection only upon a communication request by an application, or
whether User Equipments may be configured, with or without a configured APN, globally or per application, to activate a PDN connection only after a confirmation of the user only upon a communication request by an application.

As a consequence of these different possible behaviours of User Equipments, there are at least partly situations where the network resources or network services are not optimally used, e.g. in case of high load situations of the network or in case of network preferences. This has a number of drawbacks: A lot of network resources are used for signalization traffic that does not lead to enhance a customer's experience but increases the operation costs of the public land mobile network. Furthermore, repeated access requests constitute an important battery drain for the User Equipment.

### SUMMARY

An object of the present invention is to overcome—at least partly—the limitations of the current state of the art, and to provide more fine grained access control to a public land mobile network used by User Equipments:

The object of the present invention is achieved by a method for providing an access control of a User Equipment to a public land mobile network, wherein the User Equipment is equipped such that at least
a first kind of access to the public land mobile network, and
a second kind of access to the public land mobile network is possible, wherein the first kind of access to the public land mobile network and the second kind of access to the public land mobile network are selected from the group comprising:
the first kind of access being an International Mobile Subscriber Identity (IMSI) attach procedure for providing access to a Circuit Switched (CS) domain of the network, and the second kind of access being a General Packet Radio System (GPRS) or Evolved Packet System (EPS) attach procedure for providing access to a Packet Switched (PS) domain of the network,
the first kind of access being a General Packet Radio System (GPRS) or Evolved Packet System (EPS) attach procedure for providing access to a Packet Switched (PS) domain of the network, and the second kind of access being activating a Packet Data Network (PDN) connection,
the first kind of access being a General Packet Radio System (GPRS) or Evolved Packet System (EPS) attach procedure for providing access to a Packet Switched (PS) domain of the network, and the second kind of access being an International Mobile Subscriber Identity (IMSI) attach procedure for providing access to a Circuit Switched (CS) domain of the network,
the first kind of access being activating a PDN connection in the General Packet Radio System or Evolved Packet System, and the second kind of access being activating a further PDN connection in the General Packet Radio System or Evolved Packet System, wherein the access control to the public land mobile network is realized by means of a first access control information and a second access control information, wherein dependent on the first access control information, the User Equipment is connected to the public land mobile network according to the first kind of access, and wherein, dependent on the second access control information, the User Equipment is connected to the public land mobile network according to the second kind of access, wherein at least one of the first and second access control information is communicated to the User Equipment by means of either,
a communication between the public land mobile network and the User Equipment, or
an input procedure to the User Equipment via a user interface of the User Equipment.

The object of the present invention is furthermore achieved by a method for providing an access control of a User Equipment to a public land mobile network, wherein the User Equipment is equipped such that at least
a first kind of access to the public land mobile network, and
a second kind of access to the public land mobile network is possible, wherein the first kind of access to the public land mobile network and the second kind of access to the public land mobile network are selected from the group comprising:
the first kind of access being an International Mobile Subscriber Identity (IMSI) attach procedure for providing access to a Circuit Switched (CS) network, and the second kind of access being a General Packet Radio System (GPRS) attach procedure for providing access to a Packet Switched (PS) network,
the first kind of access being a General Packet Radio System (GPRS) attach procedure for providing access to a Packet Switched (PS) network, and the second kind of access being activating a Packet Data Network (PDN) connection,
the first kind of access being a General Packet Radio System (GPRS) attach procedure for providing access to a Packet Switched (PS) network, and the second kind of access being an International Mobile Subscriber Identity (IMSI) attach procedure for providing access to a Circuit Switched (CS) network,
   wherein the access control to the public land mobile network is realized by means of a first access control information and a second access control information, wherein dependent on the first access control information, the User Equipment is connected to the public land mobile network according to the first kind of access, and wherein, dependent on the second access control information, the User Equipment is connected to the public land mobile network according to the second kind of access, wherein at least one of the first and second access control information is communicated to the User Equipment by means of either,
a communication between the public land mobile network and the User Equipment, or
an input procedure to the User Equipment via a user interface of the User Equipment.

According to the present invention, it is advantageously possible to provide a much more fine grained control of the terminal behaviour with respect to requesting access to the public land mobile network according to more than one kind of access. For example, it is possible to control the activation of a Packet Data Network (PDN) connection dependent on the current situation within the public land mobile network, such as the network load or the availability of network resources, the number of User Equipments present in the current network radio cell. This advantageously provides the benefit of avoiding unnecessary access requests (and other signalling traffic) by the User Equipment (and especially by a plurality of User Equipments), which enables a better network performance for those services that can be served by the network in such a situation or e.g. high load or high demand of network resources such as Internet Protocol address resources or memory resources or the like. Furthermore, the inventive method provides the benefit of reducing the battery drain of User Equipments (mobile devices) as unnecessary access requests can be avoided and hence the associated energy consumption of the mobile devices saved.

In the context of the present invention, the term “requesting access” means:
requesting the International Mobile Subscriber Identity (IMSI) attach with respect to requesting access to a Circuit Switched (CS) domain of the network,
requesting the General Packet Radio System (GPRS) and/or Evolved Packet System (EPS) attach with respect to requesting access to a Packet Switched (PS) domain of the network, and/or
requesting a Packet Data Network (PDN) connection with respect to requesting access to a Packet Data Network (PDN).

In the context of the present invention, the term “first kind of access of the User Equipment to the public land mobile network” preferably refers to an access or a connection already established and the “second kind of access of the User Equipment to the public land mobile network” refers to a possible access or connection to be initiated (or requested) or not by the User Equipment depending on the second access control information. As one example out of a plurality of possible examples, it would be possible according to the present invention to combine two of the mentioned scenarios, e.g.
the first kind of access being an International Mobile Subscriber Identity (IMSI) attach procedure for providing access to a Circuit Switched (CS) domain of the network, and the second kind of access being a General Packet Radio System (GPRS) or Evolved Packet System (EPS) attach procedure for providing access to a Packet Switched (PS) domain of the network,
the first kind of access being a General Packet Radio System (GPRS) or Evolved Packet System (EPS) attach procedure for providing access to a Packet Switched (PS) domain of the network, and the second kind of access being activating a Packet Data Network (PDN) connection,
the first kind of access being a General Packet Radio System (GPRS) or Evolved Packet System (EPS) attach procedure for providing access to a Packet Switched (PS) domain of the network, and the second kind of access being an International Mobile Subscriber Identity (IMSI) attach procedure for providing access to a Circuit Switched (CS) domain of the network,
the first kind of access being activating a PDN connection in the General Packet Radio System (GPRS) or Evolved Packet System (EPS), and the second kind of access being activating a further PDN connection in the General Packet Radio System (GPRS) or Evolved Packet System (EPS).
   In such a combined scenario, in case that in a first point in time only the IMSI attach procedure has been performed (i.e. an access of the User Equipment to the Circuit Switched (CS) domain is realized) and (in a later second point in time after the first point in time) the possibility occurs that an attachment to the Packet Switched (PS) domain could be realized or requested, the access to the Circuit Switched (CS) domain would be the “first kind of access” and the access to the Packet Switched (PS) domain would be the “second kind of access”. If, in such a situation, also an attachment (or access) to the Packet Data Network (PDN) could be realized or requested (in a third point in time, after the second point in time), such an attachment (or access) would be (for that particular User Equipment) a “third kind of access” to the public land mobile network, but within the context of the present invention such an access to the Packet Data Network (PDN) would nevertheless be regarded as a “second kind of access to the public land mobile network” with respect to a “first kind of access to the public land mobile network” which would be to the Packet Switched (PS) domain. Analogously, other combinations of the above-mentioned scenarios are possible, also involving more than two kinds of access of the User Equipment to the public land mobile network.

According to the present invention, it is preferred that the access control of the User Equipment to the public land mobile network refers exclusively to the kind of access to the public land mobile network, i.e. to one or a plurality of the following:
the User Equipment performing the International Mobile Subscriber Identity attach with respect to requesting access to a Circuit Switched network domain,
the User Equipment performing the General Packet Radio System or Evolved Packet System attach with respect to requesting access to a Packet Switched network domain, and
the User Equipment performing a Packet Data Network connection with respect to requesting access to a Packet Data Network.

Thereby, it is advantageously possible that the kind of the access of the User Equipment to the public land mobile network can be easily controlled and network load related to signalization processes with regard to finally unsuccessful or undesired attachment or connection establishment procedures avoided. The word “exclusively” means that what is meant by “access control” in the context of the present invention relates exclusively to the kind of the attach or connection establishment procedure of the User Equipment to the public land mobile network. It does not mean that in a situation of an attached User Equipment (or after a successful attach procedure of an User Equipment to a public land mobile network or to a domain of a public land mobile network) or a User Equipment connected to a Packet Data Network, the inventive method is no longer relevant; also with an attached or connected User Equipment, there are situations where the access control information needs to be used, especially in case that the public land mobile network environment experienced by the User Equipment changes (especially due to moving the User Equipment, i.e. in situations of a location update procedure (i.e. in cases of a Location Area update procedure and/or a Tracking Area update procedure and/or a Routing Area update procedure) or of a change of the public land mobile network) or the public land mobile network transmits an access control information leading to a different attachment behaviour of the User Equipment, or a different behaviour of the User Equipment with respect to requesting access to a Packet Data Network.

It is furthermore preferred according to the present invention that the use of the first and second access control information is restricted to the following situations:
an attach procedure of the User Equipment to the public land mobile network,
a location update procedure of the User Equipment,
a connection establishment procedure towards a Packet Data Network,
a change of the public land mobile network by the User Equipment, and
upon a change of the first and/or second access control information with respect to the User Equipment.

Thereby, it is ensured that the behaviour relating to attach procedures of the User Equipment and/or the behaviour of the User Equipment with respect to requesting access to a Packet Data Network within the public land mobile network can be controlled in a fine-grained manner but without changing the behaviour of the User Equipment in other situations.

In the context of the present invention, the term location update procedure is to be understood as either a Location Area update procedure and/or a Tracking Area update procedure and/or a Routing Area update procedure.

According to the present invention, it is preferred that the first and/or the second access control information depend on the location of the User Equipment.

Thereby, it is advantageously possible to change the behaviour of the User Equipment (or of a plurality of User Equipments) in certain areas of the public land mobile network, such areas being, e.g., identified or defined by means of their cell identification (cell ID) of the respective network radio cell or by means of the Routing Area Identification (Routing Area ID) or by means of the Location Area Identification (Location Area ID) or by means of geographic coordinates (especially in case the User Equipment is provided with an interface for receiving signals of satellite navigation system such as GPS (Global Positioning System) or Galileo) or by a combination thereof. Thereby, it is possible—e.g.—to provide “home zone” services associated with a special behaviour of the mobile device (User Equipment) in such an area of the network. For example, by means of modifying the first and/or the second access control information, it is possible that an automatic establishment of a Packet Data Network (PDN) connection is effected within a certain geographic area of the public land mobile network. According to such an embodiment of the present invention, the first and/or second access control information is no static information but an information comprising a condition of the kind: “if the area identification parameter (such as, e.g., the cell ID or the Routing Area ID or the like) (received by the User Equipment usually by means of a cell broadcast information, e.g. by means of a System Information Block (SIB) message) has a certain value or a certain plurality of different (alternative) values (e.g. “if cell ID equal to ‘1234’ then connect to PDN”, or “if cell ID equal to ‘1234’ or ‘2345’ or ‘3456’ then connect to PDN”) then a certain kind of access is requested by the User Equipment. Alternatively, of course, it might be possible to apply an inverted condition of the kind: “if the area identification parameter has a different value than a specified value (or than a specified plurality of different (alternative) values) then a certain kind of access is requested by the User Equipment (e.g. “if cell ID unequal to ‘1234’ then connect to PDN”, or “if cell ID unequal to ‘1234’ or ‘2345’ or ‘3456’ then connect to PDN”). It is preferably advantageous to apply such a behaviour to the second kind of access to the public land mobile network; this means that a first kind of access to the public land mobile network is generally activated by the User Equipment (i.e. the corresponding first access control information explicitly indicates that such an access is always to be requested (or the same result is implicitly obtained by means of, e.g., hardware and/or software and/or Universal Subscriber Identity Module (USIM) settings within the User Equipment)) and the second access control information depends on the location of the User Equipment. The access control of the User Equipment depending on the location of the User Equipment also includes the possibility to permit or avoid certain kinds of access to the public land mobile network based on whether the User Equipment is roaming in a foreign public land mobile network (i.e. not the Home Public Land Mobile Network). For example, an automatic establishment of a Packet Data Network (PDN) connection might be avoided in a Visited Public Land Mobile Network due to increased roaming costs and/or due to insufficient network capacity or the like. Therefore, the first and/or second access control information can also be of the form: “if the network identification (received by the User Equipment usually by means of a broadcast message) indicates that the User Equipment is not attached to the Home Public Land Mobile Network but to a Visited Public Land Mobile Network then a certain kind of access is automatically requested by the User Equipment (or is not requested or is “forbidden” to the User Equipment).

According to the present invention, it is furthermore preferred that the User Equipment receives an availability information, wherein the availability information indicates the availability to the User Equipment:
of a Circuit Switched (CS) domain network interface of the public land mobile network, or
of a Packet Switched(PS) domain network interface of the public land mobile network, or
of an E-UTRAN (enhanced UMTS Terrestrial Radio Access Network) of the public land mobile network, or
of a GERAN (GSM Edge Radio Access Network) of the public land mobile network, or
of an UTRAN (UMTS Terrestrial Radio Access Network) of the public land mobile or network,
of an access point name (APN) available within the public land mobile network, and wherein the first and/or the second access control information depends on the availability information.

Thereby, it is advantageously possible to provide a fine grained control on the behaviour of the User Equipment with regard to a plurality of network accesses. The availability information, e.g., indicates whether an Evolved Universal Terrestrial Radio Access Network (E-UTRAN) network coverage is available to the User Equipment. Based on this availability information, the first and/or second access control information might specify that an automatic establishment of a Packet Data Network (PDN) connection should be effected in case a network coverage is currently available (such as, e.g., an Evolved Universal Terrestrial Radio Access Network (E-UTRAN) coverage (because an attempt to connect to the Packet Data Network (PDN) reduces the delay when switching to an Evolved Universal Terrestrial Radio Access Network (E-UTRAN) access of the User Equipment)). According to such an embodiment of the present invention, the first and/or second access control information is again no static information but an information comprising a condition of the kind: “if the availability information indicates the availability of a certain network coverage, e.g. Evolved Universal Terrestrial Radio Access Network (E-UTRAN) coverage, (e.g. “if a Evolved Universal Terrestrial Radio Access Network (E-UTRAN) cell is reachable then connect to PDN”) then a certain kind of access is requested by the User Equipment. It is preferably advantageous to apply such a behaviour to the second kind of access to the public land mobile network; this means that a first kind of access to the public land mobile network is generally activated by the User Equipment (i.e. the corresponding first access control information explicitly indicates that such an access is always to be requested (or the same result is implicitly obtained by means of, e.g., hardware and/or software and/or Universal Subscriber Identity Module (USIM) settings within the User Equipment)) and the second access control information depend on the availability information of a certain network coverage to the User Equipment. The availability information can, e.g., be transmitted to the User Equipment on a broadcast channel or on a shared channel or on a dedicated channel, or by a mechanism involving a preferably external application server and in a transparent manner to the public land mobile network. Furthermore, the availability information according to the present invention preferably includes an information about the availability of certain network services (or radio access technologies) with respect to the current cell (of the User Equipment) or with respect to neighbouring cells.

It is furthermore preferred according to the present invention that the availability information is obtained by a signal strength measurement of the User Equipment.

Thereby, it is easily and effectively possible to provide the availability information to the User Equipment.

Furthermore, it is preferred according to the present invention that at least one of the first and the second access control information is an information that, depending on conditions of an environment of the User Equipment,
comprises different pieces of information, and/or
takes different values,
   such that a dynamic adaption of the first and second kind of access to the public land mobile network is realized, wherein the conditions of the environment of the User Equipment are indicated by at least one out of the following:
an area identification parameter, especially the cell ID and/or the Routing Area ID and/or Location Area ID and/or Tracking Area ID,
the availability information,
the geographic coordinates or the geographic position.

Thereby, it is advantageously possible to change the behaviour of the User Equipment in certain areas of the public land mobile network, e.g. identified by an area identification parameter, especially the cell ID and/or the Routing Area ID and/or the Location Area ID and/or the Tracking Area ID, or by the availability information or by means of geographic coordinates or the geographic position. Thereby, it is possible—e.g.—to provide “home zone” services associated with a special behaviour of the mobile device (User Equipment) in such an area of the network. For example, by means of modifying the first and/or the second access control information or by means of the first and/or second access information comprising different parts of different pieces of information (for a variety of different conditions of the environment of the User Equipment), it is possible and preferred according to the present invention that the first and/or second access control information is not a static information but a dynamic information depending on conditions of an environment of the User Equipment.

According to the present invention, it is still furthermore preferred that the second access control information depends on whether the first kind of access of the User Equipment corresponds:
to an International Mobile Subscriber Identity (IMSI) attachment of the User Equipment to the public land mobile network, and/or
to a General Packet Radio System (GPRS) attachment of the User Equipment to the public land mobile network, and/or
to an Evolved Packet System (EPS) attachment of the User Equipment via the Evolved Universal Terrestrial Radio Access Network (E-UTRAN), and/or
to a connection to an access point name (APN) available within the public land mobile network.

Thereby, a granularity of the access control (with respect to a new kind of access, i.e. a kind of access by which the User Equipment is currently not yet connected to the public land mobile network) is available dependent on the current kind of access, i.e. the working or first access mode or attachment mode of the User Equipment to the public land mobile network.

Furthermore, it is advantageous that the second access control information depends on whether the second kind of access of the User Equipment corresponds:
to an International Mobile Subscriber Identity (IMSI) attachment of the User Equipment to the public land mobile network, and/or
to a General Packet Radio System (GPRS) attachment of the User Equipment to the public land mobile network, and/or
to an Evolved Packet System (EPS) attachment of the User Equipment via the Evolved Universal Terrestrial Radio Access Network (E-UTRAN), and/or
to a connection to an access point name (APN) available within the public land mobile network.

Thereby, an access control can be performed based on the kind of the additional access (the second kind of access) of the User Equipment to the public land mobile network. Especially, it is possible to differentiate between different access point names (APN), i.e. the second access control information is different dependent on the access point name (APN) to which the User Equipment wants a connection to be established.

According to a preferred embodiments of the present invention, the first and/or the second access control information or the availability information is transmitted between the public land mobile network and the User Equipment by means of:
a Non Access Stratum (NAS) communication, or
an Access Stratum (AS) communication, or
a mechanism involving a preferably external application server and in a transparent manner to the public land mobile network, or
a message broadcast in the current cell of the User Equipment.

Thereby, it is possible according to the present invention that the public land mobile network where the User Equipment currently camps can have access to a control of the behaviour of the User Equipment. According to the present invention, a mechanism involving a preferably external application server and providing the first and/or the second access control information or the availability information in a transparent manner to the public land mobile network to the User Equipment is for example: an Open Mobile Alliance (OMA) device management or a Third Generation Partnership Project (3GPP) Over the Air (OTA) mechanism, or any other over the air mechanism. This means that unnecessary duplications of access requests by means of the User Equipment can be avoided in case that, e.g., the network load is such that no additional, e.g., packet data connections can be handled by the public land mobile network. According to the present invention, this is especially relevant for controlling the second access control information, i.e. for controlling the behaviour of the User Equipment in case there is already a first (current) kind of access (or connection) established to the public land mobile network and the User Equipment (or the user of the User Equipment) is interested in having a second kind of access to the public land mobile network.

It is furthermore preferred according to the present invention that a change of the first and/or the second access control information is triggered by means of:
a Non Access Stratum (NAS) communication, or
an Access Stratum (AS) communication, or
a mechanism involving a preferably external application server and in a transparent manner to the public land mobile network, or
a message broadcast in the current cell of the User Equipment, or
a user input via the user interface of the User Equipment, or
a user input on a web site, especially a web site accessed via the User Equipment.

Thereby, it is advantageously possible that the first and/or second access control information (but especially the second access control information) is triggered to be changed and transmitted to the User Equipment in a simple and convenient manner. According to the present invention, a mechanism involving a preferably external application server and triggering a change of the first and/or the second access control information in a transparent manner to the public land mobile network to the User Equipment is for example: an Open Mobile Alliance (OMA) device management or a Third Generation Partnership Project (3GPP) Over the Air (OTA) mechanism, or any other over the air mechanism.

The present invention further relates to a public land mobile network, providing an access control for a User Equipment attached or able to be attached to the public land mobile network, wherein the public land mobile network is arranged such that for the User Equipment being equipped such that at least
a first kind of access to the public land mobile network, and
a second kind of access to the public land mobile network is possible, and
the first kind of access to the public land mobile network and the second kind of access to the public land mobile network being selected from the group comprising:
   the first kind of access being an International Mobile Subscriber Identity (IMSI) attach procedure for providing access to a Circuit Switched (CS) domain of the network, and the second kind of access being a General Packet Radio System (GPRS) or Evolved Packet System (EPS) attach procedure for providing access to a Packet Switched (PS) domain of the network,
   the first kind of access being a General Packet Radio System (GPRS) or Evolved Packet System (EPS) attach procedure for providing access to a Packet Switched (PS) domain of the network, and the second kind of access being activating a Packet Data Network (PDN) connection,
   the first kind of access being a General Packet Radio System (GPRS) or Evolved Packet System (EPS) attach procedure for providing access to a Packet Switched (PS) domain of the network, and the second kind of access being an International Mobile Subscriber Identity (IMSI) attach procedure for providing access to a Circuit Switched (CS) domain of the network,
   the first kind of access being activating a PDN connection in the General Packet Radio System (GPRS) or Evolved Packet System (EPS), and the second kind of access being activating a further PDN connection in the General Packet Radio System (GPRS) or Evolved Packet System (EPS),
      the public land mobile network realizes the access control by means of a first access control information and a second access control information, wherein dependent on the first access control information, the User Equipment is connected to the public land mobile network according to the first kind of access, and wherein, dependent on the second access control information, the User Equipment is connected to the public land mobile network according to the second kind of access, and wherein the public land mobile network is furthermore arranged such that at least one of the first and second access control information is communicated to the User Equipment by means of a communication between the public land mobile network and the User Equipment.

Additionally, the present invention further relates to a public land mobile network, providing an access control for a User Equipment attached or able to be attached to the public land mobile network, wherein the User Equipment is equipped such that at least
a first kind of access to the public land mobile network, and
a second kind of access to the public land mobile network is possible, wherein the first kind of access to the public land mobile network and the second kind of access to the public land mobile network are selected from the group comprising:
the first kind of access being an International Mobile Subscriber Identity (IMSI) attach procedure for providing access to a Circuit Switched (CS) domain of the network, and the second kind of access being a General Packet Radio System (GPRS) or Evolved Packet System (EPS) attach procedure for providing access to a Packet Switched (PS) domain of the network,
the first kind of access being a General Packet Radio System (GPRS) or Evolved Packet System (EPS) attach procedure for providing access to a Packet Switched (PS) domain of the network, and the second kind of access being activating a Packet Data Network (PDN) connection,
the first kind of access being a General Packet Radio System (GPRS) or Evolved Packet System (EPS) attach procedure for providing access to a Packet Switched (PS) domain of the network, and the second kind of access being an International Mobile Subscriber Identity (IMSI) attach procedure for providing access to a Circuit Switched (CS) domain of the network,
the first kind of access being activating a PDN connection in the General Packet Radio System (GPRS) or Evolved Packet System (EPS), and the second kind of access being activating a further PDN connection in the General Packet Radio System (GPRS) or Evolved Packet System (EPS),
   wherein the access control to the public land mobile network is realized by means of a first access control information and a second access control information, wherein dependent on the first access control information, the User Equipment is connected to the public land mobile network according to the first kind of access, and wherein, dependent on the second access control information, the User Equipment is connected to the public land mobile network according to the second kind of access, wherein at least one of the first and second access control information is communicated to the User Equipment by means of a communication between the public land mobile network and the User Equipment.

The present invention furthermore relates to a public land mobile network, providing an access control for a User Equipment attached or able to be attached to the public land mobile network, wherein the User Equipment is equipped such that at least
a first kind of access to the public land mobile network, and
a second kind of access to the public land mobile network is possible, wherein the first kind of access to the public land mobile network and the second kind of access to the public land mobile network are selected from the group comprising:
the first kind of access being an International Mobile Subscriber Identity (IMSI) attach procedure for providing access to a Circuit Switched (CS) network, and the second kind of access being a General Packet Radio System (GPRS) attach procedure for providing access to a Packet Switched (PS) network,
the first kind of access being a General Packet Radio System (GPRS) attach procedure for providing access to a Packet Switched (PS) network, and the second kind of access being activating a Packet Data Network (PDN) connection,
the first kind of access being a General Packet Radio System (GPRS) attach procedure for providing access to a Packet Switched (PS) network, and the second kind of access being an International Mobile Subscriber Identity (IMSI) attach procedure for providing access to a Circuit Switched (CS) network,
   wherein the access control to the public land mobile network is realized by means of a first access control information and a second access control information, wherein dependent on the first access control information, the User Equipment is connected to the public land mobile network according to the first kind of access, and wherein, dependent on the second access control information, the User Equipment is connected to the public land mobile network according to the second kind of access, wherein at least one of the first and second access control information is communicated to the User Equipment by means of a communication between the public land mobile network and the User Equipment.

The invention furthermore relates to a User Equipment comprising an access control functionality, wherein the User Equipment is equipped such that at least
a first kind of access to a public land mobile network, and
a second kind of access to the public land mobile network is possible, wherein the first kind of access to the public land mobile network and the second kind of access to the public land mobile network are selected from the group comprising:
the first kind of access being an International Mobile Subscriber Identity (IMSI) attach procedure for providing access to a Circuit Switched (CS) domain of the network, and the second kind of access being a General Packet Radio System (GPRS) or Evolved Packet System (EPS) attach procedure for providing access to a Packet Switched (PS) domain of the network,
the first kind of access being a General Packet Radio System (GPRS) or Evolved Packet System (EPS) attach procedure for providing access to a Packet Switched (PS) domain of the network, and the second kind of access being activating a Packet Data Network (PDN) connection,
the first kind of access being a General Packet Radio System (GPRS) or Evolved Packet System (EPS) attach procedure for providing access to a Packet Switched (PS) domain of the network, and the second kind of access being an International Mobile Subscriber Identity (IMSI) attach procedure for providing access to a Circuit Switched (CS) domain of the network,
the first kind of access being activating a PDN connection in the General Packet Radio System (GPRS) or Evolved Packet System (EPS), and the second kind of access being activating a further PDN connection in the General Packet Radio System (GPRS) or Evolved Packet System (EPS),
   wherein the access control to the public land mobile network is realized by means of a first access control information and a second access control information stored within the User Equipment, wherein the User Equipment is arranged to request to be connected, dependent on the first access control information, to the public land mobile network according to the first kind of access, and wherein, the User Equipment is arranged to request to be connected, dependent on the second access control information, to the public land mobile network according to the second kind of access, wherein the User Equipment is furthermore arranged such that at least one of the first and second access control information is communicated to the User Equipment by means of either,
a communication between the public land mobile network and the User Equipment, or
an input procedure to the User Equipment via a user interface of the User Equipment.

Additionally, the invention furthermore relates to a User Equipment comprising an access control functionality, wherein the User Equipment is equipped such that at least
a first kind of access to a public land mobile network, and
a second kind of access to the public land mobile network is possible, wherein the first kind of access to the public land mobile network and the second kind of access to the public land mobile network are selected from the group comprising:
the first kind of access being an International Mobile Subscriber Identity (IMSI) attach procedure for providing access to a Circuit Switched (CS) domain of the network, and the second kind of access being a General Packet Radio System (GPRS) or Evolved Packet System (EPS) attach procedure for providing access to a Packet Switched (PS) domain of the network,
the first kind of access being a General Packet Radio System (GPRS) or Evolved Packet System (EPS) attach procedure for providing access to a Packet Switched (PS) domain of the network, and the second kind of access being activating a Packet Data Network (PDN) connection,
the first kind of access being a General Packet Radio System (GPRS) or Evolved Packet System (EPS) attach procedure for providing access to a Packet Switched (PS) domain of the network, and the second kind of access being an International Mobile Subscriber Identity (IMSI) attach procedure for providing access to a Circuit Switched (CS) domain of the network,
the first kind of access being activating a PDN connection in the General Packet Radio System (GPRS) or Evolved Packet System (EPS), and the second kind of access being activating a further PDN connection in the General Packet Radio System (GPRS) or Evolved Packet System (EPS),
   wherein the access control to the public land mobile network is realized by means of a first access control information and a second access control information stored within the User Equipment, wherein dependent on the first access control information, the User Equipment requests to be connected to the public land mobile network according to the first kind of access, and wherein, dependent on the second access control information, the User Equipment requests to be connected to the public land mobile network according to the second kind of access, wherein at least one of the first and second access control information is communicated to the User Equipment by means of either,
a communication between the public land mobile network and the User Equipment, or
an input procedure to the User Equipment via a user interface of the User Equipment.

Still furthermore, the invention relates to a User Equipment comprising an access control functionality, wherein the User Equipment is equipped such that at least
a first kind of access to a public land mobile network, and
a second kind of access to the public land mobile network is possible, wherein the first kind of access to the public land mobile network and the second kind of access to the public land mobile network are selected from the group comprising:
the first kind of access being an International Mobile Subscriber Identity (IMSI) attach procedure for providing access to a Circuit Switched (CS) network, and the second kind of access being a General Packet Radio System (GPRS) attach procedure for providing access to a Packet Switched (PS) network,
the first kind of access being a General Packet Radio System (GPRS) attach procedure for providing access to a Packet Switched (PS) network, and the second kind of access being activating a Packet Data Network (PDN) connection,
the first kind of access being a General Packet Radio System (GPRS) attach procedure for providing access to a Packet Switched (PS) network, and the second kind of access being an International Mobile Subscriber Identity (IMSI) attach procedure for providing access to a Circuit Switched (CS) network,
   wherein the access control to the public land mobile network is realized by means of a first access control information and a second access control information stored within the User Equipment, wherein dependent on the first access control information, the User Equipment requests to be connected to the public land mobile network according to the first kind of access, and wherein, dependent on the second access control information, the User Equipment requests to be connected to the public land mobile network according to the second kind of access, wherein at least one of the first and second access control information is communicated to the User Equipment by means of either,
a communication between the public land mobile network and the User Equipment, or
an input procedure to the User Equipment via a user interface of the User Equipment.

Such a public land mobile network and such a User Equipment have the advantage that the behaviour of User Equipments attached to the public land mobile network can be controlled in a more fine grained manner, especially as regards a second (especially a data) connection of the User Equipment towards the public land mobile network. This control of especially a second kind of access to the public land mobile network is preferably provided dependent on the location of the of the User Equipment and/or dependent on the availability of network coverage (especially of different kinds of networks such as a GERAN, a UTRAN, a E-UTRAN, or a Packet Switched (PS) or a Circuit Switched (CS) domain of a public land mobile network) and/or dependent on the first kind of access of the User Equipment to the public land mobile network.

Additionally, the present invention relates to a program comprising a computer readable program code which, when executed on a computer, executes the inventive method.

### BRIEF DESCRIPTION OF THE DRAWINGS

FIG. 1 schematically illustrates a cellular public land mobile network comprising at least one radio cell with a User Equipment.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

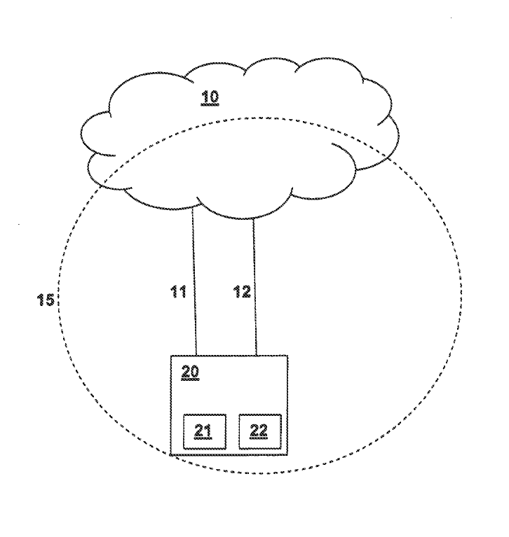

In FIG. 1, a cellular public land mobile network 10 is schematically represented. The public land mobile network 10 comprises a plurality of cells, one of which is represented by means of a dashed circle and designated by reference sign 15. The cell 15 also comprises a base station means (i.e. a fixed device such as an eNodeB or the like) having at least one antenna means such that radio coverage within the cell 15 is provided. For the sake of simplicity, the base station means is not depicted in FIG. 1. Within the coverage area of the cell 15, a User Equipment 20 is schematically illustrated. Usually, a cell 15 comprises a plurality of identical or different User Equipments such as the User Equipment 20. The User Equipment 20 is able to establish a first kind of access 11 to the public land mobile network 10, and also to establish a second kind of access 12 to the public land mobile network 10. Given a certain network transmission capacity of the cell 15 (especially determined by means of the geographical density of the respective base station means associated to the public land mobile network 10) and given a certain limitation of other network resources and given network preferences regarding the use of such network resources, the traffic data transmission capacity as well as the signalling data transmission capacity and other network resources are limited. In case that a more efficient use of the public land mobile network is possible by applying a certain behaviour of the User Equipments, the public land mobile network may have preferences regarding the access to and use of the limited network resources by the User Equipments. In case that a comparably high number of User Equipments such as User Equipment 20 is within the radio coverage area of the cell 15 and request not only a single kind of access but more than one kind of network access to the public land mobile network, it is possible that either the signalling data transmission capacity and/or the traffic data transmission capacity of the public land mobile network (at least with respect to the cell 15 in question) is reached or exceeded. Therefore, an access control of the User Equipments especially with respect to a second kind of access 12 to the public land mobile network 10 is advantageous.

1-14. (canceled)

15. A method for providing an access control of a User Equipment to a public land mobile network, wherein the User Equipment is configured to be capable of a first kind of access and a second kind of access to the public land mobile network, the method comprising:
realizing access control to the public land mobile network by:
connecting the User Equipment to the public land mobile network according to the first kind of access based on a first access control information; and
connecting the User Equipment to the public land mobile network according to the second kind of access based on a second access control information;
wherein at least one of the first access control information and the second access control information is communicated to the User Equipment by:
a communication between the public land mobile network and the User Equipment; or
an input procedure to the User Equipment via a user interface of the User Equipment; and
wherein the first kind of access and the second kind of access are selected from the group consisting of:
the first kind of access being an International Mobile Subscriber identity attach procedure for providing access to a Circuit Switched domain of the network and the second kind of access being a General Packet Radio System or Evolved Packet System attach procedure for providing access to a Packet Switched domain of the network;
the first kind of access being a General Packet Radio System or Evolved Packet System attach procedure for providing access to a Packet Switched domain of the network and the second kind of access being activating a Packet Data Network connection;
the first kind of access being a General Packet Radio System or Evolved Packet System attach procedure for providing access to a Packet Switched domain of the network and the second kind of access being an International Mobile Subscriber Identity attach procedure for providing access to a Circuit Switched domain of the network; and
the first kind of access being activating a packet data network (PDN) connection in the General Packet Radio System or Evolved Packet System and the second kind of access being activating a further PDN connection in the General Packet Radio System or Evolved Packet System.

16. The method according to claim 15, wherein realizing the access control of the User Equipment to the public land mobile network further comprises at least one of the following:
the User Equipment performing the International Mobile Subscriber Identity attach with respect to requesting access to a Circuit Switched network domain;
the User Equipment performing the General Packet Radio System or Evolved Packet System attach with respect to requesting access to a Packet Switched network domain; and
the User Equipment performing a Packet Data Network connection with respect to requesting access to a Packet Data Network.

17. The method according to claim 15, wherein using at least one of the first and second access control information is in response to an occurrence of one of the following situations:
an attach procedure of the User Equipment to the public land mobile network;
a location update procedure of the User Equipment;
a connection establishment procedure towards a Packet Data Network;
a change of the public land mobile network by the User Equipment; and
a change of at least one of the first or second access control information with respect to the User Equipment.

18. The method according to claim 15, wherein at least one of the first ca the second access control information depends on the location of the User Equipment

19. The method according to claim 15, wherein the User Equipment receives an availability information, wherein the availability information indicates the availability to the User Equipment of at least one of the following:
a Circuit Switched domain network interface of the public land mobile network;
a Packet Switched domain network interface of the public land mobile network;
an Evolved UMTS Terrestrial Radio Access Network of the public land mobile network;
a GSM Edge Radio Access Network of the public land mobile network;
a UMTS Terrestrial Radio Access Network of the public land mobile network; of
an access point name available within the public land mobile network; and
wherein at least one of the first or the second access control information depends on the availability information.

20. The method according to claim 19, wherein the availability information is obtained by a signal strength measurement.

21. The method according to claim 19, wherein dynamic adaption of the first and second kind of access to the public land mobile network is realized based on at least one of the first and the second access control information being information that varies based on conditions of an environment of the User Equipment, wherein the conditions of the environment of the User Equipment are indicated by at least one out of the following:
an area identification parameter;
the availability information; and
the geographic coordinates or the geographic position.

22. The method according to claim 21, wherein the area identification parameter is at least one of a cell ID, a Routing Area ID, a Location Area, or a Tracking Area.

23. The method according to claim 15, wherein the second access control information depends on whether the first kind of access of the User Equipment corresponds to at least one of:
an International Mobile Subscriber Identity attachment of the User Equipment to the public land mobile network;
a General Packet Radio System attachment of the User Equipment to the public land mobile network;
an Evolved Packet System attachment of the User Equipment via the Evolved Universal Terrestrial Radio Access Network; or
a connection to an access point name (APN) available within the public land mobile network.

24. The method according to claim 15, wherein the second access control information depends on whether the second kind of access of the User Equipment corresponds to at least one out of
an International Mobile Subscriber Identity attachment of the User Equipment to the public land mobile network;
a General Packet Radio System attachment of the User Equipment to the public land mobile network;
an Evolved Packet System attachment of the User Equipment via the Evolved Universal Terrestrial Radio Access Network; or
a connection to an access point name (APN) available within the public land mobile network.

25. The method according to claim 19, wherein at least one of the first and the second access control information, or the availability information, is transmitted between the public land mobile network and the User Equipment using at least one of: a Non Access Stratum communication, an Access Stratum communication, an external application server in a manner transparent to the public land mobile network, or a message broadcast in a current cell of the User Equipment.

26. The method according to claim 15, wherein a change of at least one of the first and the second access control information is triggered using at least one of a Non Access Stratum communication, an Access Stratum communication, an external application server in a manner transparent to the public land mobile network, a message broadcast in a current cell of the User Equipment, a user input via the user interface of the User Equipment, or a user input on a web site.

27. The method according to claim 26, wherein the web site is accessed by the User Equipment.

28. A public land mobile network, configured to realize access control of a User Equipment, wherein the User Equipment is configured to be capable of a first kind of access and a second kind of access to the public land mobile network, the public land mobile network being further configured to connect to the User Equipment according to the first kind of access based on a first access control information and to connect to the User Equipment according to the second kind of access based on a second access control information, and further configured to communicate at least one of the first and the second access control information to the Use Equipment, and wherein the first kind of access and the second kind of access are selected from the group consisting of
the first kind of access being an International Mobile Subscriber Identity attach procedure for providing access to a Circuit Switched domain of the network and the second kind of access being a General Packet Radio System or Evolved Packet System attach procedure for providing access to a Packet Switched domain of the network;
the first kind of access being a General Packet Radio System or Evolved Packet System attach procedure for providing access to a Packet Switched domain of the network and the second kind of access being activating a Packet Data Network connection;
the first kind of access being a General Packet Radio System or Evolved Packet System attach procedure for providing access to a Packet Switched domain of the network and the second kind of access being an International Mobile Subscriber Identity attach procedure for providing access to a Circuit Switched domain of the network; and
the first kind of access being activating a packet data network (PDN) connection in the General Packet Radio System or Evolved Packet System and the second kind of access being activating a further PDN connection in the General Packet Radio System or Evolved Packet System.

29. A User Equipment comprising an access control functionality, the User Equipment being configured to be capable of a first kind of access and a second kind of access to a public land mobile network, wherein access control to the public land mobile network is realized using a first access control information and a second access control information, the User Equipment being further configured to request to be connected to the public land mobile network according to the first kind of access based on the first access control information and to be connected to the public land mobile network according to the second kind of access based on the second access control information, the User Equipment being further configured to receive at least one of the first and the second access control information via a communication between the public land mobile network and the User Equipment or an input procedure to the User Equipment via a user interface of the User Equipment, and wherein the first kind of access and the second kind of access are selected from the group consisting of:
the first kind of access being an international Mobile Subscriber identity attach procedure for providing access to a Circuit Switched domain of the network and the second kind of access being a General Packet Radio System or Evolved Packet System attach procedure for providing access to a Packet Switched domain of the network;
the first kind of access being a General Packet Radio System or Evolved Packet System attach procedure for providing access to a Packet Switched domain of the network and the second kind of access being activating a Packet Data Network connection;
the first kind of access being a General Packet Radio System or Evolved Packet System attach procedure for providing access to a Packet Switched domain of the network and the second kind of access being an international Mobile Subscriber Identity attach procedure for providing access to a Circuit Switched domain of the network; and
the first kind of access being activating a packet data network (PDN) connection in the General Packet Radio System or Evolved Packet System and the second kind of access being activating a further PDN connection in the General Packet Radio System or Evolved Packet System.

30. A non-transitory computer-readable medium having computer-executable instructions stored thereon for providing an access control of a User Equipment to a public land mobile network, wherein the User Equipment is configured to be capable of a first kind of access and a second kind of access to the public land mobile network, the computer-executable instructions, when executed by a processor, causing the following steps to be performed:
realizing access control to the public land mobile network by:
connecting the User Equipment to the public land mobile network according to the first kind of access based on a first access control information; and
connecting the User Equipment to the public land mobile network according to the second kind of access based on a second access control information;
wherein at least one of the first access control information and the second access control information is communicated to the User Equipment by:
a communication between the public land mobile network and the User Equipment; or
an input procedure to the User Equipment via a user interface of the User Equipment; and
wherein the first kind of access and the second kind of access are selected from the group consisting of:
the first kind of access being an International Mobile Subscriber Identity attach procedure for providing access to a Circuit Switched domain of the network and the second kind of access being a General Packet Radio System or Evolved Packet System attach procedure for providing access to a Packet Switched domain of the network;
the first kind of access being a General Packet Radio System or Evolved Packet System attach procedure for providing access to a Packet Switched domain of the network and the second kind of access being activating a Packet Data Network connection;
the first kind of access being a General Packet Radio System or Evolved Packet System attach procedure for providing access w a Packet Switched domain of the network and the second kind of access being an international Mobile Subscriber Identity attach procedure for providing access to a Circuit Switched domain of the network; and
the first kind of access being activating a packet data network (PDN) connection in the General Packet Radio System or Evolved Packet System and the second kind of access being activating a further PDN connection in the General Packet Radio System or Evolved Packet System.
